(19) United States
(12) Patent Application Publication
(10) Pub. No.: US 2010/0068502 A1
(43) Pub. Date: Mar. 18, 2010

(54) EASY PEEL-OFF COATING COMPOSITION FOR ANTI-RUST COATING

(76) Inventor: Jong Min Kim, Seoul (KR)

Correspondence Address: 3M INNOVATIVE PROPERTIES COMPANY, PO BOX 33427, ST. PAUL, MN, 55133-3427, US

(21) Appl. No.: 12/066,958

(22) PCT Filed: Aug. 11, 2006
(86) PCT No.: PCT/US06/31544

§ 371 Date: Mar. 14, 2008

(30) Foreign Application Priority Data
Sep. 16, 2005 (KR) 10-2005-0086632

(51) Int. Cl. B32B 5/16; C08L 53/00; C08L 25/04

(52) U.S. Cl. 428/323; 524/577; 524/578; 524/505

(57) ABSTRACT

Disclosed is a coating composition comprising: a styrene block copolymer, a filler having a core-shell structure, silica, and a solvent. The above core-shell structured filler can improve peel-off property of a film made of styrene block copolymer based coating composition.

### TECHNICAL FIELD

The present invention relates to a coating composition for anti-rust coating, particularly to an easy peel-off coating composition for protecting steel panels or iron panels. More particularly, the present invention relates to an easy peel-off anti-rust coating composition, which shows a quick drying property, has sufficient initial adhesion strength and excellent adhesion maintenance, and can be peeled off cleanly even when applied to a rough surface leaving little or no residues on the surface after the removal.

### BACKGROUND ART

In general, an iron panel having a rough surface, which is commonly used in the manufacture of ships, etc., is coated with a FBE (Fusion Bonded Epoxy) or two-part epoxy solution on its body portion. In addition, the end portion of such panel is coated with a special material so that it can easily undergo the next process such as welding to connect it with another iron plate. According to the prior art, such end portions are coated with urethane varnish, duct tapes or Zn shop primers.

However, conventional urethane varnish has the following problems; its drying time is long (at least 1 hour), it has too strong adhesion that it is difficult to remove the coating cleanly in order for carrying out welding treatment, and it has too low viscosity as a coating solution to be coated on the end portion of a metal panel or a metal pipe. In addition, currently used duct tapes have problems in that they leave residue on a surface from which they are peeled off (particularly in summer), and they show very weak adhesion strength occasionally and thus are easily peeled, which causes water to be infiltrated between the tape and the substrate to which the tape is adhered. Additionally, Zn shop primer has a disadvantage that it is necessary to perform an additional blasting step in order to remove the primer.

In brief, conventional coating compositions having a strong adhesion have a problem that they cannot be peeled off easily or cleanly and thus residue remains after removal of such coating compositions. On the other hand, conventional easy peel-off coating compositions have a problem of low adhesion strength.

The present invention has been made in view of the above-mentioned problems.

### SUMMARY OF THE INVENTION

According to one exemplary embodiment of the present invention, there is provided a coating composition comprising a styrene block copolymer, filler having a core-shell structure, silica and a solvent.

In another exemplary embodiment of the present invention, the coating composition may further comprise an anti-rust agent so as to improve anti-rust effect.

The coating composition of the present invention has an easy peel-off property.

In particular, the coating composition according to the present invention may have the following characteristics: the coating composition can be easily removed when necessary, can provide acceptable initial adhesion strength, shows a sufficient adhesion but not so strong as to leave adhesive residues that adversely affects the following processes, and can maintain such adhesion property for its shelf life.

According to one exemplary embodiment of the present invention, the coating film formed of the coating composition of the present invention has adhesion strength (180° direction peeling) of about 2.5 kg/inch or less and thus can be easily removed when necessary; and can provide acceptable initial adhesion strength of about 0.3 kg/inch or more and thus shows a sufficient adhesion. The initial adhesion strength means an adhesion strength measured when 24 hours have passed after applying and drying the coating composition at room temperature. In addition, the amount of the residue after peeling off the coating film formed of the coating composition of the present invention is about 0.5 g/m² or less, which do not adversely affect the following processes.

According to one exemplary embodiment, the coating film formed of the coating composition may have adhesion strength of about 0.3 to about 2.5 kg/inch, and in another exemplary embodiment the adhesion strength may be about 0.3 to about 1.2 kg/inch. The amount of the residue after peeling off the coating film may be about 0.5 g/m² or less.

In one exemplary embodiments of the present invention, the coating composition may be prepared as a slurry state or paste state, and after applying to a subject and drying, the coating composition may be exist as a film state. The viscosity of the slurry or the paste may be about 1,000 to 10,000 cPs.

According to one exemplary embodiment of the present invention, the coating composition comprises 10-55 wt % of a styrene block copolymer, 0.1-15 wt % of a core-shell structured filler, 0.1-5 wt % of silica and 40-80 wt % of a solvent to the total weight of the coating composition.

In another exemplary embodiment, the coating composition may comprise 5-50 parts by weight of the filler having a core-shell structure, 1-15 parts by weight of the silica and 150-250 parts by weight of the solvent relatively based on 100 parts by weight of the styrene block copolymer contained in the coating composition. In the above, the term “part” represents a relative value of weight based on 100 parts by weight of the block copolymer, which may be useful for the expression of the component of the coating film that is formed after the coating composition has been dried.

According to one exemplary embodiment of the present invention, an anti-rust agent may be further added to coating composition. The amount of the anti-rust agent may be about 20 wt % or less to the total weight of the coating composition.

In the present invention, by adding a compound having a core-shell structure to the coating composition as filler, peel-off property improved significantly compared to that of the prior art.

In one exemplary embodiment of the present invention, the filler comprise a core portion formed of a material having rubber property and a shell portion formed of a material having compatibility with the styrene block copolymer. Because of the core portion having rubber property, it is possible to maintain elasticity of the block copolymer even when a coating composition is dried and formed to a coating film, and thus easy peel-off property is provided. Additionally, because of the shell portion having compatibility with the styrene block copolymer, the filler particles present in the coating composition are not agglomerated but dispersed uniformly, thereby providing excellent film quality.

The coating composition, particularly the coating film formed of the coating composition according to one exemplary embodiment of the present invention can protect the surface on which the film is formed from rust. In addition, the coating film can be easily removed by pulling and peeling it from one end. After removing the coating film, no or little residues remain.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a picture showing an example of the blasted panel on which a coating composition according to one exemplary embodiment of the present invention will be applied.

FIG. 2 is a picture showing weather resistance of the coating film formed of the coating composition according to one exemplary embodiment of the present invention on the blasted panel.

### DETAILED DESCRIPTION OF THE INVENTION

Hereinafter, each component forming the coating composition according to the present invention will be explained in more detail.

### Styrene Block Copolymer

The block copolymer of the present invention contains styrene, that is styrene block copolymer.

Particular examples of the block copolymer that may be used in the coating composition of the present invention include, but are not limited to styrene-butadiene-styrene block copolymers, styrene-isoprene-styrene block copolymers, styrene-ethylene-butylene-styrene block copolymers, styrene-butadiene-butylene-styrene block copolymers and styrene-ethylene-propylene-styrene block copolymers.

According to one exemplary embodiment of the present invention, the styrene block copolymer may have a molecular weight of between about 1000 and about 100,000. The styrene block copolymer can impart adhesive property and coatability to the coating composition of the present invention.

One example of the block copolymer that may be used in the present invention has a styrene content of about 15-55%, viscosity of about 10,000 cps or less in 25% toluene solution, tensile strength of about 2,000 psi or more, and a hardness (Shore A) of about 40 or more.

Not-limiting specific examples of commercially available block copolymers include Kraton D1101, D1102, D1122, D1144, D1107, D1111, D1128, D1160, Kraton G1650, G1651, G1652, Tuftec H1031, H1041, H1051, H1052, H1053, Asaprene T-411, T420, T430, T432, T436, Tuftec P1000, P2000.

In one exemplary embodiment of the present invention, the block copolymer may be used in the coating composition in an amount of about 10-55 wt % to the total weight of the coating composition.

A person skilled in the art may select a suitable block copolymer for each application of the coating composition.

### Filler

In the coating composition of the present invention, the filler has a core-shell structure.

Conventionally, core-shell type fillers have been used as impact modifier of plastics. However, the present inventors have found that such fillers as having core-shell structure can provide easy peel-off property when added in a coating composition. Thus, the present invention provides an easy peel-off coating composition comprising the filler having a core-shell structure.

The filler of the present invention may comprise a core portion positioned inside of the filler and a shell portion covering the core portion. In one exemplary embodiment of the present invention, the filler comprises a core portion formed of a rubber material and a shell portion formed of a material having compatibility with the styrene block copolymer.

As core-forming materials, acrylic polymers, poly (butadiene/styrene), poly(acrylic/styrene) and silicone rubber can be used. Additionally, as shell-forming materials, poly(methylmethacrylate) and poly(MMA/styrene) can be used.

Not-limiting specific examples of commercially available products that may be used as core-shell type filler include Durastrength 200, D300S, D320, Clearstrength W300, Paraloid EXL-2300, EXL-2600, EXL-3300, EXL-3600, EXL-5136, EXL-6600, Paraloid BTA707, BTA712, BTA717, BTA730, BTA731, BTA751, Metablen C-140, C-201, C-202, C-223, C-301, C-303, C-320, etc.

However, the core-shell type filler that may be used in the present invention is not limited to the above products, and any core-shell structured compound comprising a core portion formed of a material having rubber property and a shell portion formed of a material having compatibility with the styrene block copolymer may be used as filler in the present invention.

In one exemplary embodiment of the present invention, the filler consists of fine particles having an average particle diameter of about 100 to 500 nm, and has excellent compatibility with the styrene block copolymer, which permits the particles to be dispersed uniformly in the coating composition. And thus, the film formed after applying and drying the coating composition has excellent tensile strength, and so, it is not easily torn out nor cut off when removing or peeling it off. For reference, powdery materials having a small particle size but not having compatibility with the styrene block copolymer, for example inorganic fillers, may be dispersed uniformly in the coating composition, but they have a problem that the resultant coating film may be torn or cut during peel-off.

Because the filler according to the present invention has a core portion formed of such materials as having rubber property, it is possible to maintain elasticity of the styrene block copolymer in the coating composition and in the coating film formed of the coating composition, thereby improving the peel-off property. Additionally, because the filler has a shell portion formed of such materials as having excellent compatibility with the styrene block copolymer, the filler particles present in the coating composition are not agglomerated but dispersed uniformly, thereby providing excellent film quality after the coating composition is dried.

According to one exemplary embodiment, the filler may be used in an amount of about 0.1-15 wt % to the total weight of the coating composition.

In one exemplary embodiment, the coating composition of the present invention may comprise about 5-50 parts by weight of the core-shell structured filler relatively to the 100 parts by weight of the block copolymer. In another exemplary embodiment, the coating composition may comprise about 10-30 parts by weight of the core-shell structured filler relatively to the 100 parts by weight of the block copolymer.

A person skilled in the art may select suitable filler for each application of the coating composition.

### Solvent

The solvent that may be used in the coating composition of the present invention includes organic solvents commonly used in preparing coating compositions. There is no particular limitation in the organic solvent, as long as it permits other components forming the coating composition (i.e., the styrene copolymer, filler and silica) to be mixed and dispersed.

For example, it is possible to use at least one solvent selected from the group consisting of toluene, xylene, benzene, ethyl acetate, isopropyl acetate, n-propyl acetate, n-butyl acetate, isobutyl acetate, sec-butyl acetate, amyl acetate, pentane, hexane, heptane, mineral spirit, acetone, methyl ethyl ketone, methyl isobutyl ketone, methyl isoamyl ketone, methyl n-propyl ketone, di-acetone alcohol, cyclohexanone, isophorone, ethanol, n-propanol, isopropanol, n-butanol, isobutanol, tetrahydrofuran, 2-nitropropan, chloroform and carbon tetrachloride. It is a matter of course that a mixture of the solvents can be used.

According to one exemplary embodiment, the solvent may be used in an amount of about 40-80 wt % to the total weight of the coating composition.

In one exemplary embodiment, the coating composition of the present invention may comprise about 150-250 parts by weight of the solvent relatively to the 100 parts by weight of the styrene block copolymer. In another exemplary embodiment, the coating composition may comprise about 180-200 parts by weight of the solvent relatively to the 100 parts by weight of the styrene block copolymer.

A person skilled in the art may select a suitable solvent for each application of the coating composition.

### Silica

In one exemplary embodiment of the present invention, the silica may be fumed silica or anhydrous silica.

According to one exemplary embodiment, the fumed silica may be obtained by heating conventional silica and boiling it at high temperature under vacuum, and depositing it on a cold surface. An example of the fumed silica is dry silica.

In one exemplary embodiment, the fumed silica may be obtained by reacting silicon tetrachloride (SiCl₄) with oxygen and hydrogen.

One example of the process for preparing fumed silica is represented by the following formula:

SiCl₄+H₂+O₄→SiO₂HCl

Fumed silica may be produced in gas, particularly in fume, as its name indicates. The above process is one example of collecting silicon dioxide in the fume generated from the combustion of a silicon-containing compound. The powder obtained by the process has a very high silicon dioxide content of 99.9% or higher and has excellent fineness.

In the coating composition according to the present invention, silica serves to reduce drying time of a coating composition and to facilitate peeling-off of the coated film formed after the coating composition is dried.

Not-limiting examples of commercially available silica include CAB-O-SIL TS-500, TS-530, TS-610, TS-720, M-5, PTG, LM-130, LM-150, AEROSIL R972, R974, R104, R106, R202, R805, R812, R816, R7200, R8200, R9200, etc.

According to one exemplary embodiment, the silica may be used in an amount of about 0.1-5 wt % to the total weight of the coating composition.

In one exemplary embodiment of the present invention, the coating composition may comprise about 1-15 parts by weight of the silica relatively to the 100 parts by weight of the styrene block copolymer. In another exemplary embodiment, the coating composition may comprise about 3-8 parts by weight of the silica relatively to the 100 parts by weight of the styrene block copolymer.

A person skilled in the art may select suitable silica for each application of the coating composition.

### Anti-Rust Agent

According to one exemplary embodiment of the present invention, an anti-rust agent may be further added to coating composition in order to improve anti-rust effect. Not-limiting examples of the anti-rust agent include silica powder, colloidal silica, hardly soluble phosphates, AlH₂P₃, etc. Commercially available products that have been used for anti-rust effect can be used as anti-rust agent in the present invention.

The anti-rust agent may be contained in an amount of about 20 wt % or less to the total weight of the coating composition.

A person skilled in the art may select a suitable anti-rust agent for each application of the coating composition.

### Peel-Off Mechanism of the Coating Composition

According to one exemplary embodiment of the present invention, a coating composition is slurry state and comprises 10-55 wt % of a styrene block copolymer, 0.1-15 wt % of a core-shell structured filler, 0.1-5 wt % of a silica and 40-80 wt % of a solvent. The coating composition is applied on the surface of a subject to be protected, and dried to form a coating film. The coating film can protect the surface from rust. Additionally, the coating film can be easily removed by pulling and peeling it from one end. After removing the coating film, little residues remain in a degree of 0.5 g/m² or less, and more preferably 0.1 g/m² or less.

Reference will now be made in detail to the preferred embodiments of the present invention. In the following examples, content of each component is expressed in “part”. The term “part” represents a relative weight value based on 100 parts by weight of the styrene block copolymer.

### Example 1

### Preparation of Coating Composition

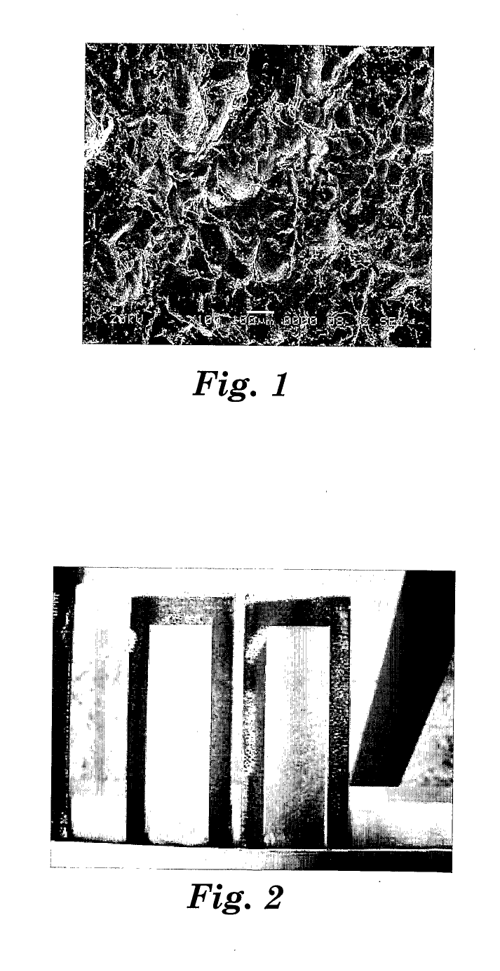

20 parts of a core-shell type filler (Metablen C223™ available from ATOFINA Co.), 100 parts of styrene-butadiene-styrene block copolymer (D1124™ available from Kraton Co.), 5 parts of fumed silica (CAB-O-SIL TS-720™ available from CABOT Corp.), and 160 parts of toluene mixed with 20 parts of xylene as solvent were mixed and stirred vigorously to provide a coating composition. The coating composition was applied on a blasted steel sheet (see FIG. 1) by means of a roller and dried at room temperature for 24 hours for the following experiment.

### Example 2

50 parts of a filler (Metablen C223™ available from ATOFINA Co.), 100 parts of a copolymer (D1124™ available from Kraton Co.), 2 parts of fumed silica (CAB-O-SIL TS-720™ available from CABOT Corp.), and 220 parts of toluene mixed with 20 parts of xylene as solvent were mixed and stirred vigorously to provide a coating composition. The coating composition was applied on a blasted steel sheet in the same manner as Example 1 and dried at room temperature for the following experiment.

### Comparative Example 1

Example 1 was repeated to provide a coating composition, except that the filler used in Example 1 was not used.

### Comparative Example 2

Example 1 was repeated to provide a coating composition, except that neither the filler nor the fumed silica used in Example 1 was used.

### Comparative Example 3

A commercially available duct tape comprising an adhesive portion based on natural rubber and a support layer formed of PVC was applied on a blasted steel sheet in the same manner as Example 1.

### Experimental Example

### 1. Drying Test

Each of the coating compositions according to Examples 1 and 2 and Comparative Examples 1 and 2 was measured for drying time based on ASTM D1640-03. After applying each coating composition on a surface, the coated surface was pushed lightly with a finger and the time at which point a fingerprint cannot be seen clearly on the coating surface was measured. The results are shown in Table 1.

TABLE 1

| | Ex. 1 | Ex. 2 | Comp. Ex. 1 | Comp. Ex. 2 |
|---|---|---|---|---|
| Drying Time | 11 mins. | 8 mins. | 28 mins. | 39 mins. |

### 2. Adhesion Test

Each of the coating compositions according to Examples 1 and 2 and Comparative Examples 1 to 3 was measured for 180° peel adhesion strength to a blasted steel panel, based on JISZ541. The test was carried out after storing the surface coated with each coating composition for 24 hours and 1 week at room temperature. Comparative Example 3 was tested after the tape was attached to a steel panel and stored the panel for 24 hours and 1 week. The results are shown in Table 2.

TABLE 2

| | | | Comp. | Comp. | Comp. |
|---|---|---|---|---|---|
| | Ex. 1 | Ex. 2 | Ex. 1 | Ex. 2 | Ex. 3 |
| Adhesion Strength after | 0.7 | 0.4 | 1.9 | 2.6 | 1.5 |
| 24 hrs (kg/inch) | | | | | |
| Adhesion after 1 week | 0.9 | 0.6 | 2.8 | 3.6 | 1.7 |
| (kg/inch) | | | | | |

### 3. Anti-Rust Effect Test

Each of the coating compositions according to the above Examples and Comparative Examples was measured for anti-rust effect against saline based on ASTM D610-01. A coated sample was disposed in a saline spray tester maintained at a temperature of 35° C.±2° C. with a slant of 45 degrees. In this test, saline having a specific gravity of 1.0255-1.0400 at 25° C. was sprayed at a rate of 1-2 ml/hr·80 cm².

Anti-rust effect was graded by area in rust, from level 0 (50% or more of area in rust) to level 10 (0.01% or less of area in rust). The results are shown in Table 3.

The coating compositions according to Examples 1 and 2 and Comparative Examples 1 and 2 showed excellent anti-rust effect represented by level 10. However, the coating agent according to Comparative Example 3 showed level 4 (3-10% of area in rust).

TABLE 3

| | Ex. 1 | Ex. 2 | Comp. Ex. 1 | Comp. Ex. 2 | Comp. Ex. 3 |
|---|---|---|---|---|---|
| Anti-rust Level | 10 | 10 | 10 | 10 | 4 |

### 4. Easy Peel-Off Test

The following test was performed in order to measure the peel-off property of each of the coating compositions according to the above Examples and Comparative Examples, on a blasted steel panel. After each coating composition was applied on a blasted steel panel and dried at room temperature for 24 hours, the sample was stored in a constant temperature/constant humidity device maintained at a temperature of about 70° C. and a humidity of about 90% for 1 week. After being taken out of the device and left at room temperature for 1 hour, each sample was subjected to an adhesion test using an Instron tester in order to measure the adhesion strength and the amount of residues. The results are shown in Table 4.

TABLE 4

| | Ex. 1 | Ex. 2 | Comp. Ex. 1 | Comp. Ex. 2 | Comp. Ex. 3 |
|---|---|---|---|---|---|
| Adhesion | 0.8 | 0.6 | 2.7 | 3.8 | 2.4 |
| Strength | | | | | |
| (kg/inch) | | | | | |
| Residual | 0.05 | 0 | 1.1 | 1.7 | 3.9 |
| Amount (g/m²) | | | | | |

As can be seen from the foregoing, the coating composition according to the present invention comprising a filler having a core-shell structure provides excellent peel-off property. In addition, the coating composition according to the present invention shows a quick drying property at room temperature, and prevents a blasted steel panel from generation of rust by adhering firmly thereto at least for 3 months. Additionally, the coating composition according to the present invention can be removed cleanly leaving little or no residues.

While this invention has been described in connection with what is presently considered to be the most practical and preferred embodiment, it is to be understood that the invention is not limited to the disclosed embodiment and the drawings. On the contrary, it is intended to cover various modifications and variations within the spirit and scope of the appended claims.

1. A coating composition comprising a styrene block copolymer, filler having a core-shell structure, silica and a solvent.

2. The coating composition according to claim 1, wherein the silica is fumed silica or anhydrous silica.

3. The coating composition according to claim 1, wherein the amount of the styrene block copolymer is about 10-55 wt %, the filler having a core-shell structure is about 0.1-15 wt %, the silica is about 0.1-5 wt % and the solvent is about 40-80 wt % to the total weight of the coating composition.

4. The coating composition according to claim 1, wherein the styrene block copolymer is selected from the group consisting of styrene-butadiene-styrene block copolymers, styrene-isoprene-styrene block copolymers, styrene-ethylene-butylene-styrene block copolymers, styrene-butadiene-butylene-styrene block copolymers and styrene-ethylene-propylene-styrene block copolymers.

5. The coating composition according to claim 1, wherein the styrene block copolymer has a styrene content of about 15-55%.

6. The coating composition according to claim 1, wherein the filler comprises a core portion formed of a material having rubber property and a shell portion formed of a material having compatibility with the styrene block copolymer.

7. The coating composition according to claim 6, wherein the core-forming material of the filler is selected from the group consisting of acrylic polymers, poly(butadiene/styrene), poly(acrylic/styrene) and silicone rubber.

8. The coating composition according to claim 6, wherein the shell-forming material of the filler is selected from the group consisting of poly(methylmethacrylate) and poly(MMA/styrene).

9. The coating composition according to claim 1, which further comprises an anti-rust agent.

10. The coating composition according to claim 2, wherein the fumed silica is obtained by reacting silicon tetrachloride (SiCl₄) with oxygen and hydrogen.

11. The coating composition according to claim 1, wherein the solvent is at least one selected from the group consisting of toluene, xylene, benzene, ethyl acetate, isopropyl acetate, n-propyl acetate, n-butyl acetate, isobutyl acetate, sec-butyl acetate, amyl acetate, pentane, hexane, heptane, mineral spirit, acetone, methyl ethyl ketone, methyl isobutyl ketone, methyl isoamyl ketone, methyl n-propyl ketone, di-acetone alcohol, cyclohexanone, isophorone, ethanol, n-propanol, isopropanol, n-butanol, isobutanol, tetrahydrofuran, 2-nitropropan, chloroform and carbon tetrachloride.

12. The coating composition according to claim 1, wherein the adhesion strength the coating film formed of the coating composition is about 0.3 to about 2.5 kg/inch.

13. The coating composition according to claim 1, wherein the amount of the residue after peeling off the coating film formed of the coating composition is about 0.5 g/m² or less.

14. A metal substrate coated with the coating composition according to claim 1.

15. The metal substrate according to claim 14, wherein the adhesion strength the coating film formed of the coating composition is about 0.3 to about 2.5 kg/inch.

16. The metal substrate according to claim 14, wherein the amount of the residue after peeling off the coating film formed of the coating composition is about 0.5 g/m² or less.

17. A method for protecting metals, which comprises applying the coating composition according to claim 1 onto the metals.
